(19) United States
(12) Patent Application Publication
(10) Pub. No.: US 2005/0068582 A1
(43) Pub. Date: Mar. 31, 2005

(54) Systems and methods for providing printing with document indicia

(76) Inventor: Andrew R. Ferlitsch, Tigard, OR (US)

Correspondence Address: Michael F. Krieger;Kirton & McConkie, 1800 Eagle Gate Tower, 60 East South Temple, Salt Lake City, UT, 84111, US

(21) Appl. No.: 10/676,984

(22) Filed: Sep. 30, 2003

(51) Int. Cl. G06F 15/00

(52) U.S. Cl. 358/1.18; 358/1.13

(57) ABSTRACT

Systems and methods for dynamically adding one or more document indicia when rendering an image without the use of a printer driver. In an image rendering system, a multi-subfile extension is used to represent multiple sub-images of a single page. A tree extension is used to efficiently group and locate sub-images. A NewSubfile Type tag is used to support sub-image types for overlays, underlays and composites/matting. A tag is used for specifying the order to merge page and sub-images. A tag is used for specifying the relative location within a page or sub-image to merge another sub-image or page image. A tag is used for specifying the relating scaling of a sub-image within a page or sub-image when merging the sub-image. A pre-fabricated form is used for page numbering. A pre-fabricated sub-image database of tile images is used for page numbers.

### BACKGROUND OF THE INVENTION

1. Field of the Invention

The present invention relates to rendering an image. In particular, the present invention relates to systems and methods for dynamically adding one or more document indicia (e.g., watermarks, page numbers, etc.) when rendering an image, such as an image in a tagged image file format (TIFF) or other format, without the use of a printer driver.

2. Background and Related Art

Techniques are currently available to add document indicia (e.g., a watermark, page number, or notice/caption) to a document or image being printed by pre-processing the document or image data into printer ready data. In one technique a printer driver is used that supports document indicia in the rendering process. In this technique, the TIFF image is loaded into a compatible application, such as an imaging application currently available on the Microsoft® Windows family of operating systems. From the application, the user specifies the intent to print the image and selects an installed printer, which has an associated printer driver. The selected printer driver is then loaded, and the printer driver displays to the user a dialog for selecting printing options. The dialog generally provides several categories of printing options, including options related to adding document indicia to the print job.

After the user selects the printing and document indicia options, the application sends the printing instructions for the TIFF image data to the printer driver via the graphical display interface (GDI). The printer driver then converts the printing instructions into printer ready data and may further modify the printer ready data based on the printing options, such as the document indicia.

While this technique is currently available, a number of problems exist. For example, this technique requires utilization of an application that is compatible with the TIFF format and is capable of initiating a print job, requires a printer driver to be used to convert the TIFF image data into printer ready data, can only add document indicia support by the printer driver, and requires that the rendering of the document indicia be performed on the client.

Another available technique allows the document indicia to be added by a second application in a two printer driver pass, and upstream from the final printer driver. In this technique, the TIFF image is loaded into a first compatible application. From this first compatible application, the user specifies the intent to print the image and selects an application specific printer driver for a second application. The application specific printer driver journals the printing instructions (e.g., EMF) and passes the journaled printing instructions to the second application, which loads the printer specific printer driver and plays back the journaled printing instructions to the printer specific printer driver. The document indicia is added by the second application by playing back pre-constructed printing instructions for the document indicia and playing them back to the printer specific printer driver.

By playing both sets of printing instructions back, the two sets are merged together. In the case of an overlay, document indicia are played before the document. In the case of an underlay, document indicia are played after the document.

While this technique is currently available, it also provides challenges. For example, the technique requires a first application that is compatible with the TIFF format and is capable of initiating a print job, requires a printer driver to convert the TIFF image data into printer ready data, requires a second application that is compatible with TIFF stored as journaled printing instructions, requires a second application specific printer driver, requires that the TIFF image data conversion do a double pass through the printer drivers, and requires that the rendering of the document indicia be done on the client.

Thus, while techniques currently exist that are used to add document indicia (e.g., a watermark, page number, or notice/caption) to a document or image being printed by pre-processing the document or image data into printer ready data, challenges still exist. For example, when image data that is in TIFF is sent directly to a printer, a user is unable to subsequently add text or labels to the image data. If the user desires to include watermarks, page numbers or notice information (e.g., “Confidential” or “Attorney Client Privilege”), current technology requires the use of a printer driver to add the information by preprocessing the image data into printer ready data. Accordingly, it would be an improvement in the art to augment or even replace current techniques with other techniques.

### SUMMARY OF THE INVENTION

The present invention relates to rendering an image. In particular, the present invention relates to systems and methods for dynamically adding one or more document indicia (e.g., watermarks, page numbers, etc.) when rendering an image, such as an image in a tagged image file format (TIFF) or other format, without the use of a printer driver.

Implementation of the present invention takes place in association with an imaging rendering system that adds document indicia when rendering images without the use of a printer driver. A multi-subfile extension is used to represent multiple sub-images of a single page, such as the page image and a watermark. A tree extension is used to efficiently group and locate sub-images, such as a single watermark sub-image for all page images. A NewSubfile Type tag is used to support sub-image types for overlays (e.g., form, page numbering), underlays (e.g., watermark) and composites/matting. A tag is used for specifying the order to merge page and sub-images. A tag is used for specifying the relative location within a page or sub-image to merge another sub-image or page image. A tag is used for specifying the relating scaling of a sub-image within a page or sub-image when merging the sub-image. A pre-fabricated form is used for page numbering. A pre-fabricated sub-image database of tile images is used for page numbers.

While the methods and processes of the present invention have proven to be particularly useful in the area of rendering print jobs with document indicia, those skilled in the art will appreciate that the methods and processes can be used in association with a variety of imaging jobs dynamically adding document indicia (e.g., watermarks, page numbers, etc.) when rendering a TIFF image without the use of a printer driver. Other types of imaging jobs include fax jobs, scan jobs, document management jobs, etc. Moreover, while the methods and processes of the present invention have proven to be particularly useful in the area of rendering TIFF images, those skilled in the art will appreciate that the methods and processes can be used in association with a variety of other document and/or image formats that support multiple pages or images. One such example is a PDF format.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 is a networked system configuration in accordance with a representative embodiment of the present invention;

FIG. 3 illustrates a representative base line layout of a TIFF image;

FIG. 4 illustrates a representative multi-page format of a TIFF image;

FIG. 5 illustrates a representative multi-subfile format of a TIFF image

FIG. 6 illustrates a representative tree format of a TIFF image;

FIG. 7 illustrates representative subfile types for an overlay process, an underlay process, and a composite process;

FIG. 8 illustrates a representative tree format of a TIFF image having representative subfile types for an overlay process, an underlay process, and a composite process;

FIG. 9 illustrates representative subfile types for an underlay (watermark) on only a first page;

FIG. 10 illustrates representative subfile types for an underlay (watermark) on all pages;

FIG. 11 illustrates representative subfile types for an underlay (watermark) with reduced images;

FIG. 12 illustrates representative subfile types for an overlay, such as a form, header, or footer;

FIG. 13 illustrates representative subfile types for an overlay with page numbering; and

FIG. 14 illustrates representative subfile types for merging page numbers with page forms.

### DETAILED DESCRIPTION OF THE INVENTION

The present invention relates to rendering an image. In particular, the present invention relates to systems and methods for dynamically adding one or more document indicia (e.g., watermarks, page numbers, etc.) when rendering an image, such as an image in a tagged image file format (TIFF) or other format, without the use of a printer driver.

Embodiments of the present invention take place in association with an image rendering system that adds document indicia when rendering images without the use of a printer driver. In one embodiment, a multi-subfile extension is used to represent multiple sub-images of a single page, such as the page image and a watermark. A tree extension is used to efficiently group and locate sub-images, such as a single watermark sub-image for all page images. A NewSubfile Type tag is used to support sub-image types for overlay (e.g., form, page numbering), underlays (e.g., watermark) and matting. A tag is used for specifying the order to merge page and sub-images. A tag is used for specifying the relative location within a page or sub-image to merge another sub-image or page image. A tag is used for specifying the relating scaling of a sub-image within a page or sub-image when merging the sub-image. A pre-fabricated form is used for page numbering. A pre-fabricated sub-image database of tile images is used for page numbers.

In the disclosure and in the claims the term “imaging job” shall refer to any type of job that can be rendered at an imaging device. Examples include print jobs, fax jobs, scan jobs, text and/or graphics for printing, document management, and the like.

The following disclosure of the present invention is grouped into two subheadings, namely “Exemplary Operating Environment” and “Rendering with Document Indicia.” The utilization of the subheadings is for convenience of the reader only and is not to be construed as limiting in any sense.

### Exemplary Operating Environment

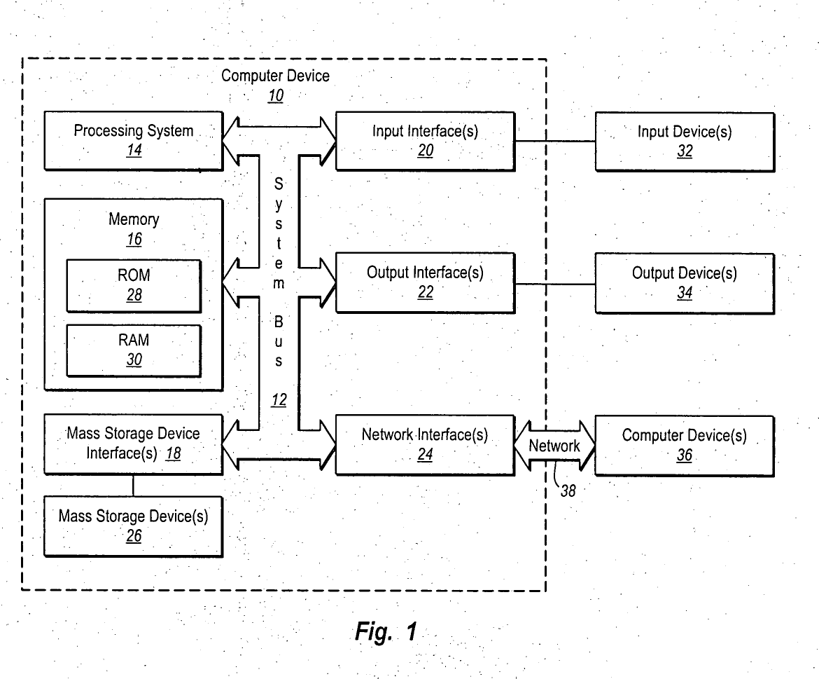

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, some embodiments of the present invention embrace local printer environments, network printer environments, remote printer environments, etc. In one embodiment, the system configuration includes one or more imaging devices (e.g., multifunctional peripherals “MFP” or other imaging devices), one or more client computer devices, optionally a server computer device, and a network communication that enables transmitting information relating to imaging jobs. Other embodiments of the present invention embrace one or more computer devices locally or remotely connected to a plurality of imaging devices for the rendering of imaging jobs.

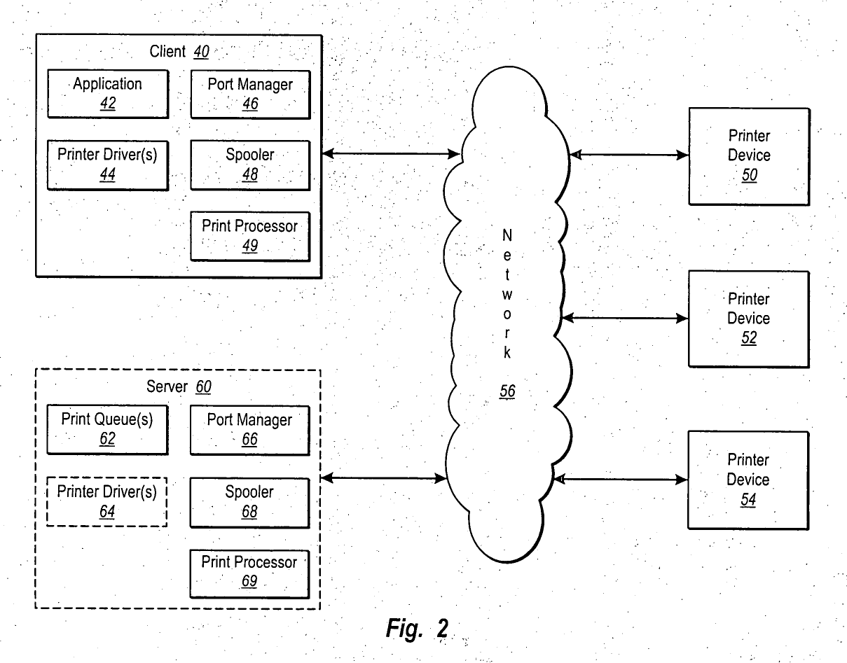

Thus, while those skilled in the art will appreciate that embodiments of the present invention may be practiced in a variety of different environments with many types of system configurations, FIG. 2 provides a representative networked configuration that may be used in association with the present invention. While FIG. 2 illustrates an embodiment that includes a client, three printer devices, and optionally a print server connected to a network, alternative embodiments include more than one client, less than three printer or other imaging devices, more than three printer or other imaging devices, no server, and/or more than one server connected to a network. Moreover, other embodiments of the present invention include local, networked, or peer-peer imaging environments, where one or more computer devices are connected to a plurality of imaging devices for rendering imaging jobs. Some embodiments include wireless networked environments, or where the network is a wide area network, such as the Internet.

The representative system of FIG. 2 includes a computer device, illustrated as client 40, which is connected to a plurality of printer devices 50-54 across network 56. In FIG. 2, printer devices 50-54 may be any type of imaging device that may be used to render a imaging job. In one embodiment, the capabilities of any one of the printer devices are heterogeneous to the capabilities of any other printer device (e.g., at least one of the capabilities of one printer device, such as printer device 50, are different from the capabilities of another printer device, such as printer device 52). In another embodiment, the capabilities of the printer devices are homogeneous.

As provided above, while printer devices 50-54 are connected to network 56, embodiments of the present invention embrace the use of imaging devices that are locally connected to a computer device, that are configured in a peer-to-peer imaging environment, or that are configured in a wireless network environment.

In the illustrated embodiment, client 40 includes a software application 42, one or 110 more print drivers 44, a port manager 46, a spooler 48, and a print processor 49. A server 60 is optionally included having, for example, one or more print queues 62, one or more printer drivers 64, a port manager 66, a spooler 68, and a print processor 69.

In the illustrated embodiment, a, the printing device (e.g., printing device 50) includes support in the firmware for reading and printing TIFF formats without rasterization. Additionally, printing device 50 includes a bypass pipeline from the PDL input directly to the TIFF printing, bypassing the PDL interpreter and renderer. The bypass pipeline and firmware support are an example of means for directly printing a TIFF image with one or more document indicia.

Thus, in accordance with the illustrated embodiment and other embodiments of the present invention, one or more document indicia are dynamically added when rendering an image without prior pre-processing the data into printer ready data, such as with the use of a printer driver, as will be further discussed below.

### Rendering with Document Indicia

As provided above, embodiments of the present invention relates to rendering an image. In particular, the present invention relates to systems and methods for dynamically adding one or more document indicia (e.g., watermarks, page numbers, etc.) when rendering an image, such as a TIFF image, PDF image or image/document in other format, without the use of a printer driver.

In at least one embodiment, a TIFF reader is specified by the 6.0 version of the TIFF specification for a baseline TIFF reader, and additionally supports the following industry common extensions: (i) a multiple image TIFF format; (ii) a multiple new subfile type for a thumbnail and transparency mask; and (iii) an Adobe® TIFF tree extension.

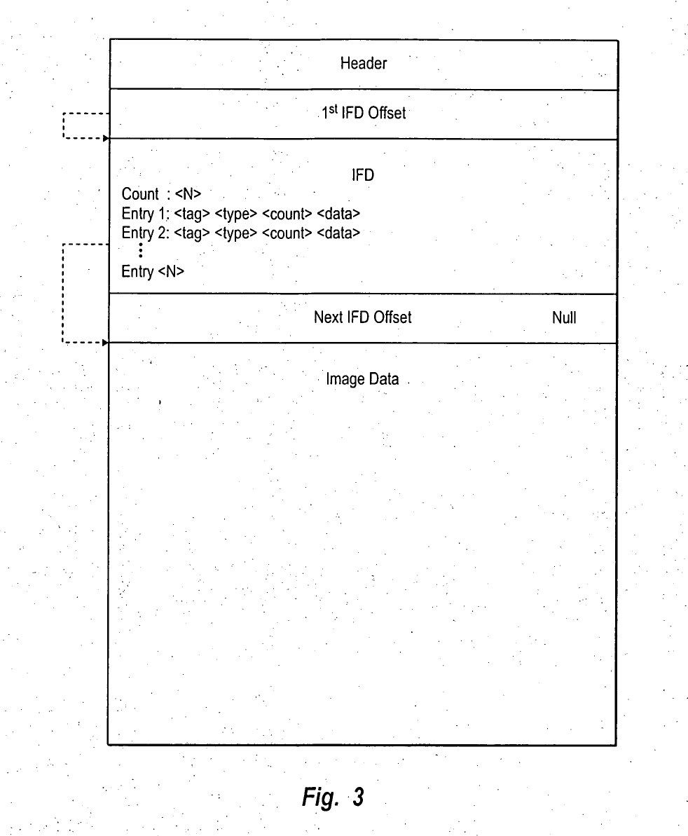

With reference to FIG. 3, a representative base line layout of a TIFF image is provided. The illustrated baseline layout is a TIFF 6.0 baseline format required for all TIFF 6.0 readers. In the baseline, only one image is required to be recognized. The format includes embedded image data, an image file directory describing the image data (i.e., IFD) and an image file header describing the layout of the file. The image file header includes a unique identifier, indicating that this is a TIFF 6.0 file format, a flag indicating the encoding of integer data (e.g., big vs. little endian) and a pointer to the IFD describing the first image.

The IFD includes one or more directory entries that describe characteristics of or manipulations for the corresponding image data. Examples include a compression mode, a location of image data, a size/resolution of the image data, a rotation of the image data, etc. The directory entries are preceded by a count of the number of directory entries in the IFD and followed by the offset to the IFD for the next image.

Each directory entry of the illustrated embodiment is of a fixed size, and includes a tag, data type, the number of values and a value field. The tag field is a 16 bit field, where each bit combination uniquely identifies a command (e.g., opcode). The TIFF 6.0 definition defines a command for 75 bit values and leaves the remaining (32,765-75) free for proprietary use by others.

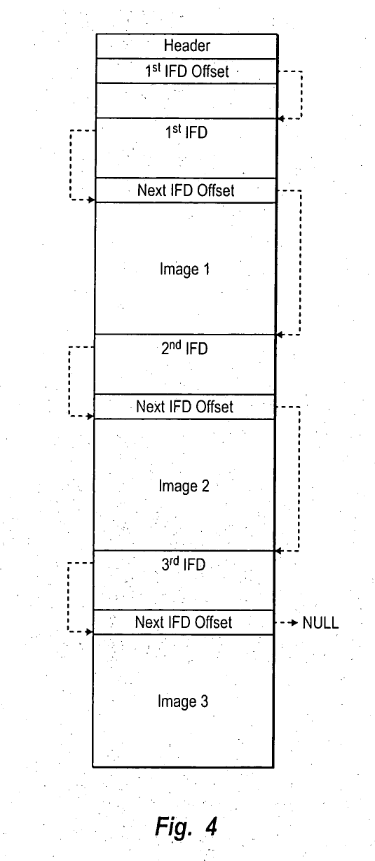

An extension specified in the TIFF 6.0 specification, but not required by baseline TIFF 6.0 readers, is for multi-image formats. In this extension, the reader reads past the first IFD. Multiple images are constructed as a combination of IFDs and image data, where each IFD is linked to the next IFD in an ordered sequence through the Next IFD Offset field (e.g., offset to the IFD for the next image). FIG. 4 is a representative depiction of this TIFF extension, wherein FIG. 4 illustrates a representative multi-page format of a TIFF image.

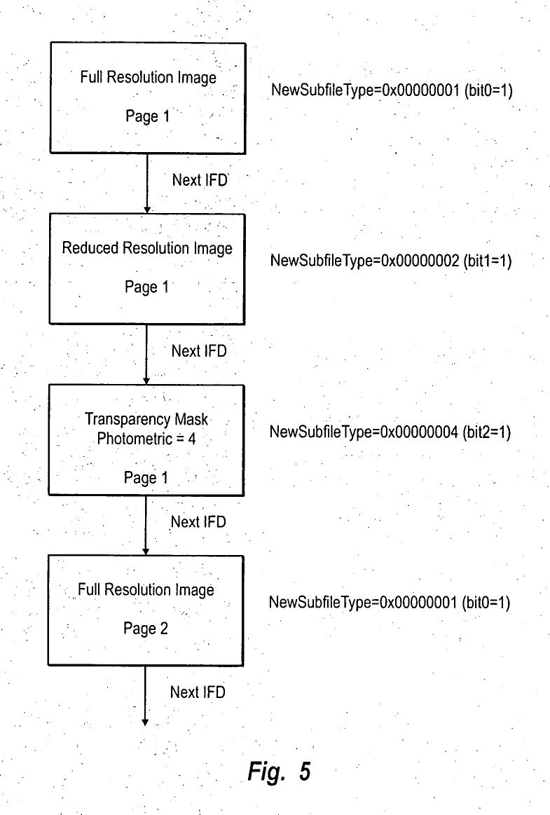

Another extension specified in the TIFF 6.0 specification, but not required by baseline TIFF 6.0 readers, is for multiple sub-files, where a sub-file is a sub-image of another image. The extension is implemented by the tag NewSubfile Type. The tag value field is a 32 bit field that designates each sub-file type. The specification specifies the first three bits and leaves the remainder free for proprietary use by others. The three sub-file types are (i) full image resolution of a page; (ii) reduced resolution of another page (e.g., thumbnail); and (iii) transparency mask of another page. FIG. 5 is a representative depiction of this TIFF extension.

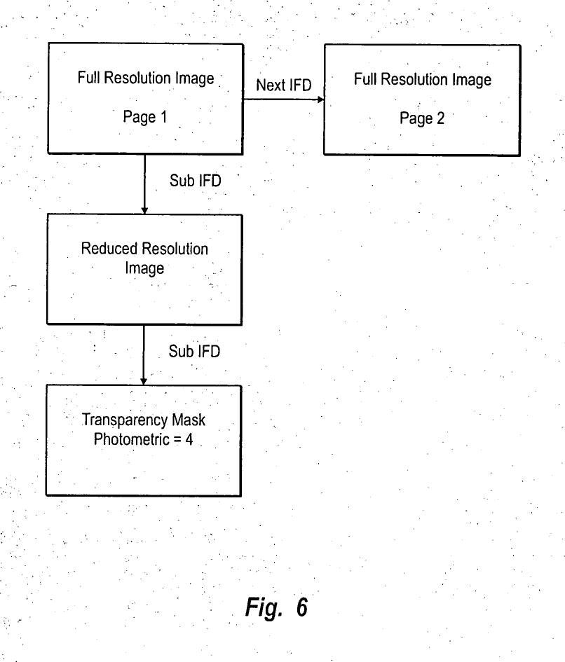

Another extension is for TIFF trees. The TIFF Tree extension allows the sub-chaining of TIFF sub-images into a tree structure. Related sub-images may be grouped into a sub-chain and located without traversing the entire chain of TIFF images. The extension is implemented by the tag SubIFD. The tag value is an offset to the next sub-image in the sub-chain. FIG. 6 is a representative depiction of this TIFF extension.

In accordance with at least some embodiments of the present invention, several new sub-file types are introduced as an extension to the baseline TIFF 6.0 specification. The new sub-file types are: (i) overlay image; (ii) underlay image; and (iii) composite image. The extension is implemented by using the next three unused bit fields (bits 3, 4 and 5) of the tag value for NewSubfile Type for designating the new sub-file types.

An overlay is an image that is laid on top of another image. Any dots/pixels in the overlay cover the corresponding dots/pixels in the other image. In the case of digital imaging, the underlying dots/pixels in the image are erased. For example, a form is one type of an overlay.

An underlay is an image that is laid below another image. Any dots/pixels in the other image cover the corresponding dots/pixels in the underlay. In the case of digital imaging, the underlying dots/pixels in the underlay are erased. For example, a watermark is one type of an underlay.

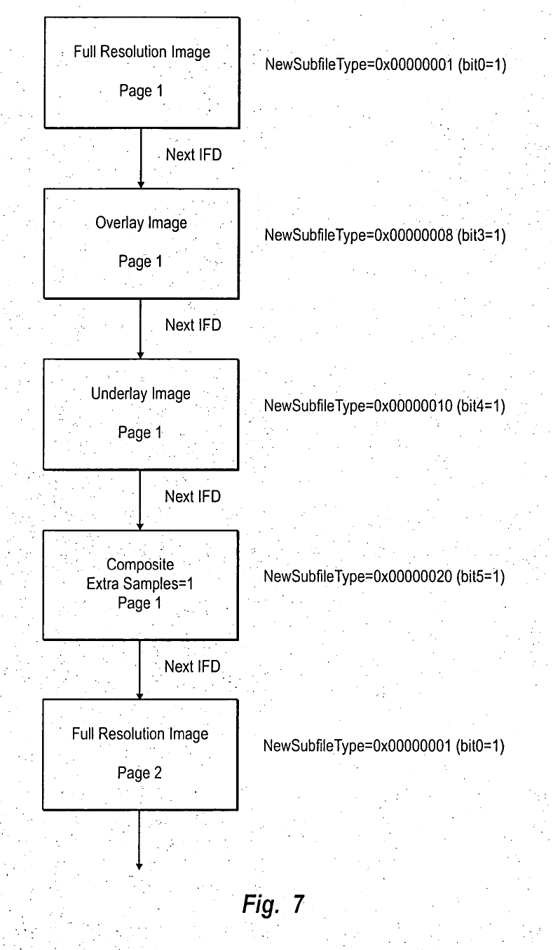

A composite is an image that is merged with another image. Any dots/pixels in the composite image that cover dots/pixels in the other image are merged into a composite. The matting may be specific to either the composite, the image or a combination of both. FIG. 7 is a representative embodiment illustrating subfile types for an overlay, underlay and composite.

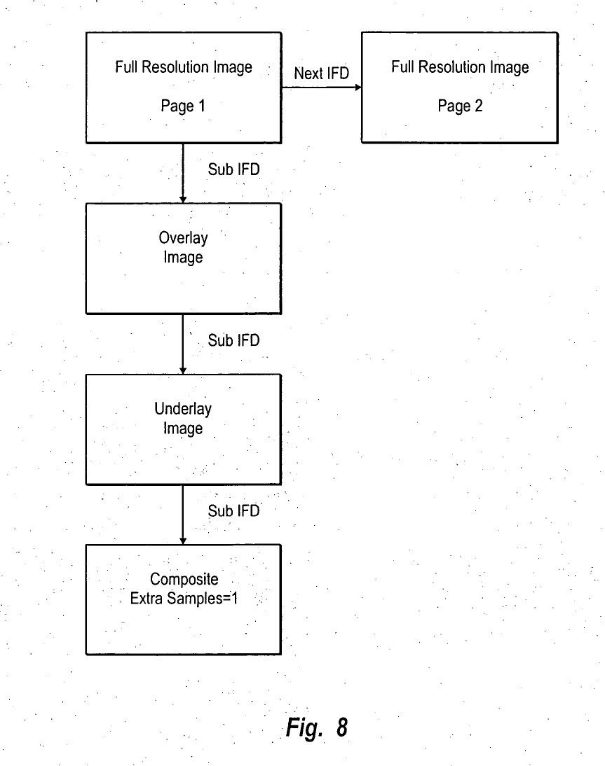

The chaining of the new sub-file types may be done as a single chain, where the page number specifier identifies the related sub-images, or by the use of sub-chains as in the TIFF tree extension. An example is represented in FIG. 8, which illustrates a representative tree format of a TIFF image having representative subfile types for an overlay, an underlay, and a composite.

In the present embodiment, several new tag types are introduced as extensions to the baseline TIFF 6.0 specification. The new tag types are: (i) MergeSubfileIFD; (ii) MergeSubfileX; (iii) MergeSubfileY; (iv) MergeSubfileScaleX; and (v) MergeSubfileScaleY. The new tag type MergeSubfileIFD is used to specify an ordered subset of the sub-images that are to be applied to another image or sub-image. That is, while a sub-chain may contain a list of sub-images, they may not all be merged, or may not be merged in the order they appear in the chain. The list of sub-file IFDs is specified as an array of offsets to the IFDs of the sub-images, and the length of the array is specified by the count field. A sub-image may include its own list of sub-images to merge. For example, a page image may merge a first sub-image, where the first sub-image merges a second sub-image. The merge of the second sub-image is first applied to the first sub-image, and the post-merged first sub-image is then merged with the page image.

The new tag types MergeSubfileX and MergeSubfileY are used to specify a location in the image to merge the sub-image. If no MergeSubfileX and MergeSubfileY are specified, the location X=0 and Y=0 is used by default. For example, the sub-image may be a strip representing a footer of a page image. The X and Y merge coordinates may be a prespecified border on the bottom of the page. If the tag values are −1, then the sub-image is merged instead with the previous sub-image in the chain. In the above example, the X and Y coordinates specified by the page image of the second sub-image is −1.

The new tag types MergeSubfileScaleX and MergeSubfileScaleY are used to specify the scale factor to apply to the sub-image when merged with the image. In no MergeSubfileScaleX and MergeSubfileScaleY are specified, the sub-image is not scaled. If −1 is specified, the sub-image is scaled to fit. For example, the above footer might be scaled according to the footer margin area of the page image. The following is a representative example of using MergeSubfile tags:

| <tag> | <type> | <count> | <value> |
|---|---|---|---|
| MergeSubFileIFD | LONG | N | Sub IFD Offset |
| MergeSubFileX | LONG | N | X Location |
| MergeSubFileY | LONG | N | Y Location |
| MergeSubFileScaleX | RATIONAL | N | X scale |
| MergeSubFileScaleY | RATIONAL | N | Y scale |

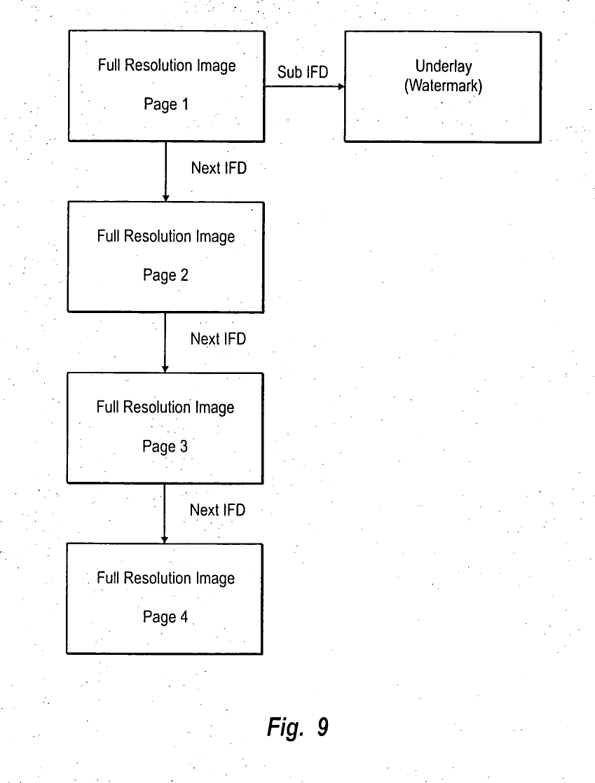

As provided above, a watermark may be implemented as an underlay. For example, a document where the first page has a watermark may be represented by chaining the page images using the NextIFDOffset and sub-chaining the watermark sub-image to the first page image. FIG. 9 is a representative example of an underlay.

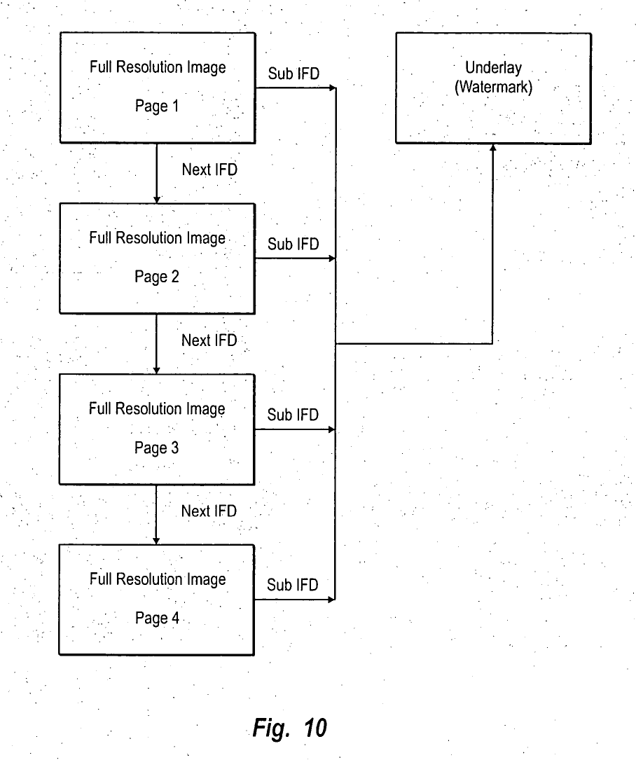

In another embodiment, as illustrated in FIG. 10, a document where all the pages share the same watermark may be represented by chaining the page images using the NextIFDOffset and each page image sub-chained to the same watermark sub-image.

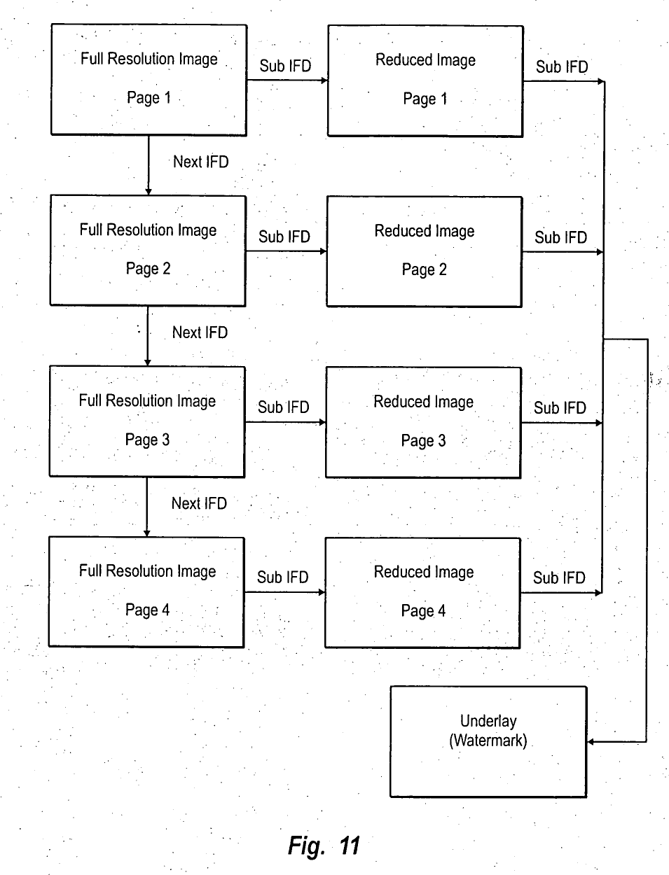

Page images may sub-chain different watermark images, and watermark images can be scaled to fit different page sizes. In at least some embodiments, the new sub-image types are combined with other sub-image types. For example, a TIFF file may include a chain of full resolution pages, where each page image is sub-chained to a thumbnail image of the page image, which are sub-chained to a common watermark. In this example, the full resolution and thumbnail representation of the page are associated with the same watermark. A representative embodiment is illustrated as FIG. 11.

In accordance with an embodiment of the present invention, a form may be implemented as an overlay. For example, a document where each page has a common header, footer or form may be represented by chaining the page images using the NextIFDOffset and sub-chaining the header, footer or form sub-image to the first page image.

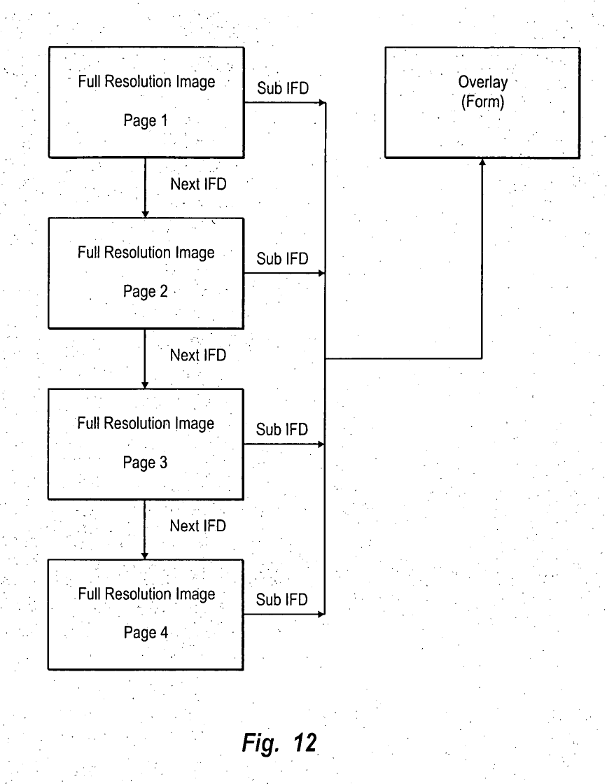

With reference to FIG. 12, a representative embodiment is illustrated, wherein all of the pages are sub-chained to the form.

In accordance with an embodiment of the present invention, page numbering may be implemented by a combination of techniques. For example, where each page will include the word “Page” at the bottom of the page followed by a page number that is specific to that page, each page may be chained together using the NextIFDOffset. Since the word “Page” is common to each page, the word “Page” is implemented as a sub-image overlay that is merged by each page image, using the MergeSubfileIFD tag. Each page specifies the location within the page image to merge the “Page” form and the scaling of the sub-image, using the MergeSubfileX/Y and MergeSubfileScaleX/Y tags.

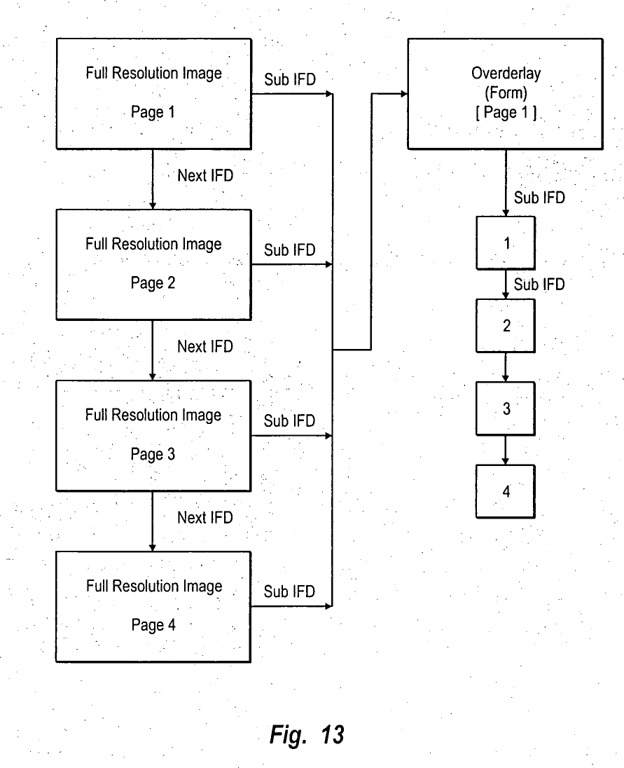

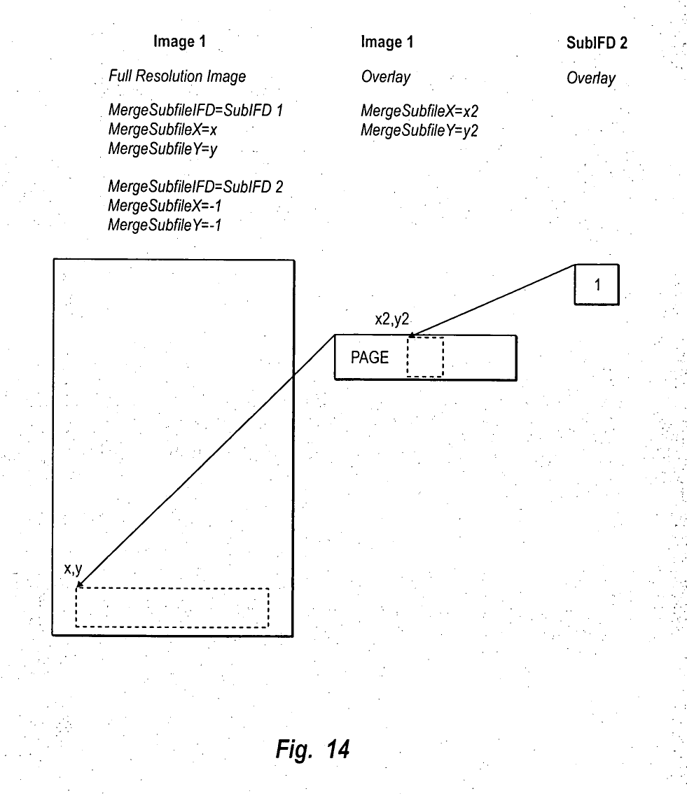

The page numbers are implemented as a chain of tile images, one per page number (e.g., database of numbers), sub-chained to the “Page” form. Each page image specifies its specific page number from the page number tile sub-chain to merge as the next sub-image. The page number location and size is assumed specific to the “Page” form and not the page image. This is implemented by the “Page” form specifying the location and scale within the “Page” form to merge the page number tile, and the corresponding page image specifying −1 for the MergeSubfileX/Y and MergeSubfileScaleX/Y tags (e.g., the page number tile is merged into the “Page” form, which is then merged into the page image). Representative examples are illustrates as FIGS. 13 and 14, wherein FIG. 13 illustrates representative subfile types for an overlay with page numbering and FIG. 14 illustrates representative subfile types for merging page numbers with page forms.

While reference has been made to TIFF images, those skilled in the art will appreciate that embodiments of the present invention also embrace other document and image formats they support the concept of multiple pages or images (e.g., PDF and other formats).

In accordance with other embodiments of the present invention, regardless of the actual document or image format, one or more document indicia is unbound from the page data where the indicia is stored as separate sub-images in the native format of the document. A representation (embedded or in an outside file) associates the pages and the sub-images, such as: (i) pages that are linked together in a next list; (ii) sub-images that are sub-chained form page images by a sub list; and (iii) sub-images that are sub-chained within sub images. The sub-images include: (i) overlay; (ii) underlay; and (iii) composite/matte. A set of instructions, dynamically or statically created define an ordered subset of sub-images to apply to the page image, wherein an overlay is applied on top of the page image, an underlay is applied below the page image, and a composite is a merge. In one embodiment, an ordered set of sub-images are within a sub-image (e.g., applied to the sub-image). The application of the sub-image to a page or sub-image is: (i) location (X,Y coordinate); (ii) scaled; and (iii) scaled to fit.

Thus, as discussed herein, the embodiments of the present invention embrace rendering an image. In particular, the present invention relates to systems and methods for dynamically adding one or more document indicia (e.g., watermarks, page numbers, etc.) when rendering a image without the use of a printer driver. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In an image rendering environment, a method for dynamically adding one or more document indicia to a document when rendering the document, the method comprising:
providing a rendering job in a format that supports at least one of (i) multiple pages, and (ii) multiple images;
storing one or more document indicia as separate sub-images in a native format;
correlating one or more pages of the document with one or more of the sub-images;
defining an ordered subset of the sub-images to apply to the document; and
using a process to associate the one or more sub-images with one or more of the pages of the document when rendering the document, wherein the process is one of (i) an overlay process, (ii) an underlay process, and (iii) a composite process.

2. A method as recited in claim 1, wherein the format is one of:
(i) a tagged image file format; and
(ii) a portable document format.

3. A method as recited in claim 1, wherein the document indicia is disbound from page data of the rendering job.

4. A method as recited in claim 1, wherein the step for correlating one or more pages of the document with one or more of the sub-images comprises a step for linking the one or more pages in a next list.

5. A method as recited in claim 1, wherein the step for correlating one or more pages of the document with one or more of the sub-images comprises a step for sub-chaining the one or more sub-images from page images by a sub list.

6. A method as recited in claim 1, wherein the step for correlating one or more pages of the document with one or more of the sub-images comprises sub-chaining the one or more sub-images within sub-images.

7. A method as recited in claim 1, wherein the step for defining an ordered subset of the sub-images comprises creating a set of instructions in one of (i) a dynamic manner, and (ii) a static manner.

8. A method as recited in claim 1, wherein the overlay process includes applying an overlay on top of one of:
(i) a page image; and
(ii) another sub-image.

9. A method as recited in claim 8, wherein the overlay is one of:
(i) a form;
(ii) a page numbering;
(iii) a header;
(iv) a footer; and
(v) a caption.

10. A method as recited in claim 1, wherein the underlay process includes applying an underlay below at least one of:
(i) a page image; and
(ii) another sub-image.

11. A method as recited in claim 10, wherein the underlay is a watermark.

12. A method as recited in claim 1, wherein the composite process includes merging a composite with at least one of:
(i) a page image; and
(ii) another sub-image.

13. In a printing environment, a method for adding document indicia when printing an image without the use of a printer driver, the method comprising:
using a multi-subfile extension to represent multiple sub-images of a TIFF image, wherein data of the TIFF image is not converted into printing instructions by an application;
using an extension to group and locate the sub-images on a page;
providing one or more electronic tags to perform at least one of:
supporting an overlay of the multiple sub-images on the page;
supporting an underlay of the multiple sub-images on the page;
supporting a composite of the multiple sub-images on the page;
specifying a merge order of the multiple sub-images on the page;
specifying a location for merging the multiple sub-images on the page; and
specifying any scaling of the multiple sub-images; and
selectively rendering the TIFF image based on the electronic tags.

14. A method as recited in claim 13, wherein the overlay is applied on top of one of:
(i) a page image; and
(ii) another sub-image.

15. A method as recited in claim 14, wherein the overlay is one of:
(i) a form;
(ii) a page numbering;
(iii) a header;
(iv) a footer; and
(v) a caption.

16. A method as recited in claim 13, wherein the underlay is applied below at least one of:
(i) a page image; and
(ii) another sub-image.

17. A method as recited in claim 16, wherein the underlay is a watermark.

18. A method as recited in claim 13, wherein the merge is performed on a composite and at least one of:
(i) a page image; and
(ii) another sub-image.

19. A computer program product for implementing within a computer system a method for dynamically adding one or more document indicia to a document when rendering the document, the computer program product comprising:
a computer readable medium for providing computer program code means utilized to implement the method, wherein the computer program code means is comprised of executable code for implementing the steps for:
initiating a rendering job, wherein the rendering job is in a format that supports at least one of (i) multiple pages, and (ii) multiple images;
storing one or more document indicia as separate sub-images in a native format;
correlating one or more pages of the document with one or more of the sub-images;
defining an ordered subset of the sub-images to apply to the document; and
using a process to associate the one or more sub-images with one or more of the pages of the document when rendering the document, wherein the process is one of (i) an overlay process, (ii) an underlay process, and (iii) a composite process.

20. A computer program product as recited in claim 19, wherein the format is one of (i) a tagged image file format and (ii) a portable document format.

21. A computer program product as recited in claim 19, wherein the step for correlating one or more pages of the document with one or more of the sub-images comprises at least one of:
linking the one or more pages in a next list;
sub-chaining the one or more sub-images from page images by a sub list; and
sub-chaining the one or more sub-images within sub-images.

22. A computer program product as recited in claim 19, wherein the step for defining an ordered subset of the sub-images comprises creating a set of instructions in one of (i) a dynamic manner, and (ii) a static manner.

23. A computer program product as recited in claim 19, wherein the overlay process includes applying an overlay on top of a page image, wherein the underlay process includes applying an underlay below the page image, and wherein the composite process includes merging a composite and at least one of:
(i) the page image; and
(ii) another sub-image.

24. A computer program product as recited in claim 23, wherein the overlay is one of:
(i) a form;
(ii) a page numbering;
(iii) a footer;
(iv) a header; and
(v) a caption.

25. A computer program product as recited in claim 23, wherein the underlay is a watermark.
